(19) United States
(12) Patent Application Publication
(10) Pub. No.: US 2005/0136296 A1
(43) Pub. Date: Jun. 23, 2005

(54) Controlling a fuel cell system

(76) Inventors: Dustan L. Skidmore, Latham, NY (US); Chris Comi, Niskayuna, NY (US); David A. Gutenmann, Clifton Park, NY (US); Ryan Hallum, Saratoga, NY (US)

Correspondence Address: TROP PRUNER & HU, PC, 8554 KATY FREEWAY, SUITE 100, HOUSTON, TX, 77024, US

(21) Appl. No.: 10/744,586

(22) Filed: Dec. 23, 2003

(51) Int. Cl. H01M 8/00; H01M 8/04; H01M 8/10; H01M 8/12; H01M 8/18

(52) U.S. Cl. 429/13; 429/17; 429/32; 429/19; 429/22; 429/23

(57) ABSTRACT

A technique that is usable with a fuel cell system includes using a stored energy source to supply power to a load, placing a fuel cell stack in an inactive state during the using, returning the fuel cell stack to an active state to recharge the stored energy source and returning the fuel cell stack to the inactive state in response to the completion of the charging. Another technique may include determining a system power demand in the fuel cell system and may include determining whether a fuel cell stack is exhibiting unstable behavior during an interval of low power demand from the fuel cell stack. In response to these determinations, the fuel cell stack is isolated from the fuel cell system. Another technique includes pulsing a fuel processor of the fuel cell system with an input reactant flow to minimize at least one of a power loss and a startup time of the fuel processor.

### BACKGROUND

The invention generally relates to controlling a fuel cell system.

A fuel cell is an electrochemical device that converts chemical energy produced by a reaction directly into electrical energy. For example, one type of fuel cell includes a polymer electrolyte membrane (PEM), often called a proton exchange membrane, that permits only protons to pass between an anode and a cathode of the fuel cell. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following equations:
H₂→2H⁺+2e⁻ at the anode of the cell, and Equation 1
O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

A fuel cell system may include a fuel processor that converts a hydrocarbon (natural gas or propane, as examples) into a fuel flow for the fuel cell stack. For a given output power of the fuel cell stack, the fuel flow to the stack must satisfy the appropriate stoichiometric ratios governed by the equations listed above. Thus, a controller of the fuel cell system may determine the appropriate output power from the stack and based on this determination, estimate the fuel flow to satisfy the appropriate stoichiometric ratios. In this manner, the controller regulates the fuel processor to produce this flow, and in response to controller determining that the output power should change, the controller estimates a new rate of fuel flow and controls the fuel processor accordingly.

The fuel cell system may provide power to an external load, such as a load that is formed from residential appliances and electrical devices that may be selectively turned on and off to vary the power that is consumed by the load. Thus, the power that is consumed by the external load may not be constant, but rather, the power that is consumed by the load may vary over time and abruptly change in steps. For example, if the fuel cell system provides power to a house, different appliances/electrical devices of the house may be turned on and off at different times to cause the power that is consumed by the external load to vary in a stepwise fashion over time.

One type of conventional fuel cell system includes a fuel cell stack that operates at a fixed operating point. Thus, the output power from the fuel cell stack remains constant. Such a conventional fuel cell system does not adjust the total power demanded from the fuel cell stack in accordance with the power that is demanded by the external load. Rather, other loads to the stack are adjusted to keep the fuel cell stack operating at the fixed setpoint. For example, when the power demanded by the external load is relatively low, the stack may furnish more power to a power grid, parasitic loads to the stack may be increased, etc. so that the system has an overall constant output power that does not vary in accordance with the power that is demanded by the external load. Thus, this type of conventional system may be generally inefficient.

Therefore, it may be desirable for the fuel cell system to have a variable output power so that the total power output of the system follows the power that is demanded by the external load. In such a system, the fuel cell stack typically supplies a power that varies over a certain range to track the power that is demanded by the external load. However, at the low and high ends of this range, the fuel cell stack and possibly other components of the fuel cell system may be relatively inefficient. Furthermore, the life of the fuel cell stack may be significantly reduced when the fuel cell stack operates near the boundaries of the range.

Thus, there is a continuing need for an arrangement and/or technique to address one or more of the problems that are stated above. There may also be continuing need for an arrangement and/or technique to address one or more problems that are not stated above.

### SUMMARY

In an embodiment of the invention, a technique that is usable with a fuel cell system includes using a stored energy source of the system to supply power to an external load, placing a fuel cell stack of the system in an inactive state during the using, returning the fuel cell stack to an active state to recharge the stored energy source and returning the fuel cell stack to the inactive state in response to the completion of the charging.

In another embodiment of the invention, a technique that is usable with a fuel cell system includes determining a system power demand in a fuel cell system and in response to the determination, isolating a fuel cell stack from the fuel cell system.

In another embodiment of the invention, a technique that is usable with a fuel cell system includes determining whether a fuel cell stack is exhibiting unstable behavior during an interval of lower power demand from the fuel cell stack and in response to the determination, isolating the fuel cell stack from the fuel cell system.

In yet another embodiment of the invention, a technique includes pulsing a fuel processor with an input reactant to minimize at least one of a power loss and startup time of the fuel processor.

Advantages and other features of the invention will become apparent from the following drawing, the description and claims.

### BRIEF DESCRIPTION OF THE DRAWING

FIG. 1 is a schematic diagram of a fuel cell system according to an embodiment of the invention.

FIGS. 2, 3 and 4 are flow diagrams depicting operation of the fuel cell system according to embodiments of the invention.

### DETAILED DESCRIPTION

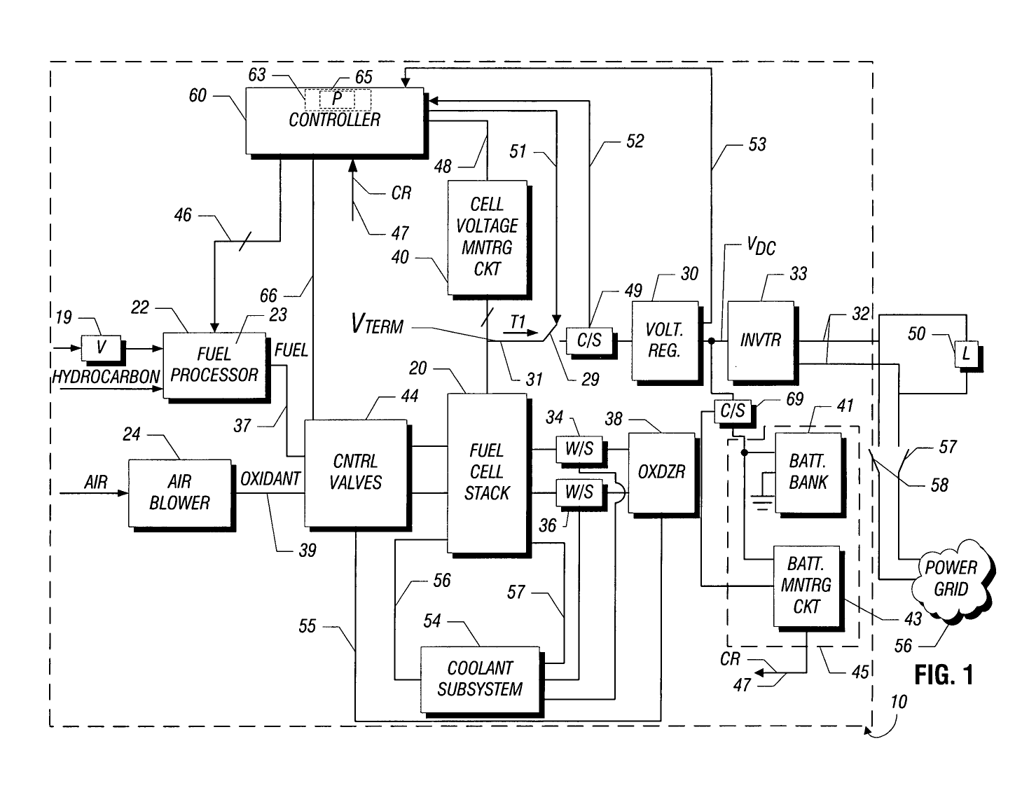

Referring to FIG. 1, an embodiment of a fuel cell system 10 in accordance with the invention includes a fuel cell stack 20 (a PEM-type fuel cell stack, for example) that is capable of producing power that is used (as described below) to power an external load 50 (a residential load, for example) of the system 10 as well as parasitic elements (valves, fans, etc.) of the system 10 in response to fuel and oxidant flows that are provided by a fuel processor 22 and an air blower 24, respectively. In this manner, the fuel cell system 10 controls the fuel production of the fuel processor 22 (i.e., controls the rate at which the fuel processor 22 provides reformate) to control the fuel flow that is available for electrochemical reactions inside the fuel cell stack 20. Reactant control valves 44 of the fuel cell system 10 generally route most of this fuel flow to the stack 20. In some embodiments of the invention, the remainder of the fuel flow may be diverted (via a conduit 55) to a flare, or oxidizer 38.

The power that is produced by the fuel cell stack 20 is ultimately consumed by the external load 50, parasitic elements of the fuel cell system 20 and possibly a power grid 56 (when switches 57 and 58 are closed, a scenario not assumed for purposes of simplifying the following description). If the fuel flow inside the fuel cell stack 20 is sufficient to satisfy the appropriate stoichiometric relationships (defined by Eqs. 1 and 2 above), the fuel cell stack 20 produces the appropriate level of power for the total system power demand (i.e., the total amount of power demanded by the external load 50 and the various loads of the fuel cell system 10). Unconsumed, or unreacted, fuel passes through the fuel cell stack 20 to the oxidizer 38.

In some embodiments of the invention, the fuel cell system 10 includes a stored energy source that is used as an energy transfer mechanism for the fuel cell stack 20. More specifically, as described below, in some embodiments of the invention, the stored energy source provides power directly to the external load 50 and serves as an energy buffer so that the fuel cell stack 20 may (when active) operate at a fixed power output while the stored energy source produces a power output that follows the power that is demanded by the external load 50. As described in the various embodiments below, it is assumed that this stored energy source includes a bank of electrically connected battery cells (lead acid battery cells, for example), referred to as the “battery bank 41” herein. However, in other embodiments of the invention, another stored energy source may be used in place of the battery bank 41.

In some embodiments of the invention, the fuel cell stack 20 is “inactive” when the reactant flows to the stack 20 are shut off to isolate the stack 20, as further described below. Otherwise, the fuel cell stack 20 is “active.” In some embodiments of the invention, the fuel processor 22 is “inactive” when the fuel processor 22 is turned down to the point at which the fuel processor is just warm enough to self-ignite when the reformate flow is to be re-established to the fuel cell stack 20, as further described below.

In accordance with some embodiments of the invention, the battery bank 41 is the direct source of power for the external load 50 and supplies power that follows the power that is demanded from the load 50. Thus, the power that is produced by the battery bank 41 is variable, depending on the power that is demanded by the load 50. Unlike conventional load following fuel cell systems, the power that is output from the fuel cell stack 20 does not generally follow the load 50. Rather, when active, the fuel cell stack 20 operates at essentially the same operating point and thus, when active, produces a fixed output power, regardless of the power that is demanded by the external load 50. Because the battery bank 41 is used to provide power to the external load 50 and has an output power that follows the power that is demanded from the load 50, the fuel cell system 10 is a load following system.

In some embodiments of the invention, the power from the fuel cell stack 20 is used to recharge the battery bank 41 after the bank 41 is drained to a predetermined state of charge. During their active states, the fuel cell stack 20 and the fuel processor 22 operate at generally fixed points that may be the most efficient system operating points, i.e., the operating points, at which degradation of the fuel cell stack is the least or the operating points at which the fuel cell stack 20 has the highest efficiency.

In some embodiments of the invention, the sole function of the fuel cell stack 20 is to charge the battery bank 41. Therefore, in these embodiments of the invention, when the battery bank 41 is not being charged, the fuel cell system 10 returns the fuel cell stack 20 and the fuel processor 22 to their inactive states of operation. Thus, essentially, in some embodiments of the invention, only the battery bank 41 directly powers the load 50; and the primary function of the fuel cell stack 20 is to recharge the battery bank 41.

The advantages of the above-described arrangement may include one or more of the following. First, this arrangement may allow the fuel cell system 20 to operate at a fixed operating point at which less degradation occurs to the fuel cell stack 20. In this manner, the degradation of a fuel cell stack 20 is not constant over its potential operating range. Rather, the degradation may be much greater at the low or high ends of the stack's operating range. In particular, the degradation may be much greater at low current densities. Thus, operation of the fuel cell stack 20 at low current densities may be a significant contributor to stack degradation in residential applications where fuel cell systems must supply power to the load at the lower end of the turndown range for lengthy intervals of time. However, with the arrangement set forth above, the fuel cell system 20 operates at a fixed setpoint for purposes of charging the battery bank 41. Thus, the system 10, in some embodiments of the invention, uses the battery bank 41 to directly supply power to the load 50 at levels that, if this power were directly supplied by the stack, would cause high degradation to the fuel cell stack 20.

An additional advantage of the above-described arrangement is that the lifetime of the fuel cell stack 20 is increased. More specifically, if the power that is demanded by the load 50 is less than the fixed output power of the fuel cell stack 20. The above-described approach can greatly reduce the amount of time the fuel cell stack 20 is in use. Furthermore, operation of the fuel cell stack at a constant current level also allows for a simplified design of an inverter 33 (see FIG. 1) of the fuel cell system 10, as compared to a design in which the inverter 33 varies the current that is provided by the fuel cell stack 20.

As a more specific example of this latter point, in a hypothetical scenario, the power demanded by the external load 50 may be 500 Watts (W) AC for five hours; and for the scenario, the operating range of the fuel cell stack 20 is assumed (as an example) to be 500 W to 5000 W AC. In a traditional load following system, the stack may operate at 500 W for five hours to supply the power that is demanded by the load; and such operation of the stack may reduce the stack life by ten hours and force the stack to operate at the edge of its turndown range, at which power to the stack may be extremely inefficient. However, using the above-described technique in accordance with some embodiments of the invention, the battery bank 41 supplies the 500 W to the external load 50 for five hours. This removes 2500 W-Hr of energy from the battery bank 41. The fuel cell stack 20 may then operate at a fixed setpoint of 2500 W and recharge the battery bank 41 in approximately 60 minutes (as compared to 5 hours), excluding any parasitic loses. This means that the stack life is only reduced by 60 minutes, and the stack may operate at a more efficient operating point (i.e., an operating point of 2500 W, as compared to operating at the lower end of its range at 500 W).

Another possible advantage of this arrangement is that the complexity and cost of the fuel cell system 10 is greatly decreased if the fuel processor 22 and the fuel cell stack 20 operate at fixed operating points instead of operating over an entire range. This eliminates the need for actuators and sensors that otherwise may be required to dynamically change flow rates, pressures, temperature, etc.

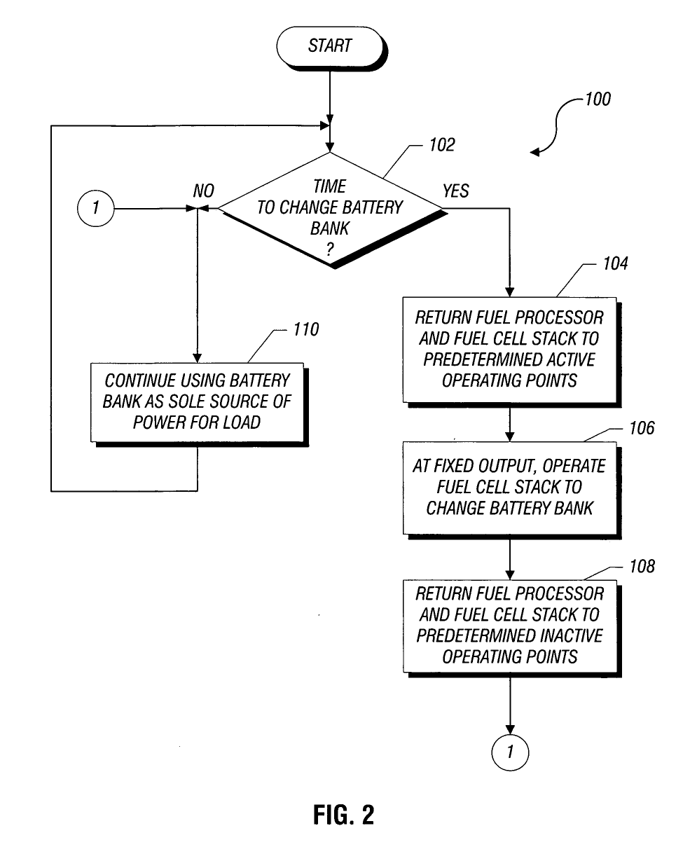

Thus, in accordance with some embodiments of the invention, the fuel cell system 10 may use a technique 100 that is depicted in FIG. 2. In accordance with the technique 100, the fuel cell system 10 determines (diamond 102) whether it is time to charge the battery bank 41. In some embodiments of the invention, the decision in diamond 102 may be aided via a battery monitoring circuit 43 (See FIG. 1). The battery monitoring circuit 43 may be part of a battery circuit 45 that includes the battery bank 41 and monitors the power received by and furnished from the battery bank 41 (and thus, determines the net energy currently stored in the battery bank 41). As an example, the battery monitoring circuit 43 may monitor the incoming power to the battery bank and monitor the outgoing power from the battery bank 41 by monitoring a terminal voltage of the battery bank 41 and a current (via a current sensor 69 (FIG. 1)) flowing to and from the battery bank 41.

Pursuant to the technique 100 (FIG. 2), upon determining that it is time to charge the battery bank 41 (diamond 102), the fuel cell system 10 returns the fuel processor 22 and the fuel cell stack 20 to predetermined active operating points, as depicted in block 104. As an example, if the power output range for the fuel cell system is 500 to 5000 W, the fuel processor 22 and fuel cell stack 20 may be operated so that the fuel cell stack 20 provides a constant output power of 2500 W when active.

Next, according to the technique 100, the fuel cell stack 20 operates (block 106) at the fixed power output to charge the battery bank 41. As described further below, in some embodiments of the invention, the fuel cell system 10 controls when the battery bank 41 charges by regulating a terminal voltage of the battery bank 41.

Subsequently, pursuant to the technique 100, the fuel cell system 10 returns (block 108) the fuel processor 22 and the fuel cell stack 20 to predetermined inactive operating points; and continues (block 110) using the battery bank 41 as the sole source of power for the external load 50 until the fuel cell system 10 determines (diamond 102) that it is time to charge the battery bank 41 once again.

In some embodiments of the invention, the fuel cell system 10 may vary the operating point of the fuel cell stack 20 so that the stack 20 generally tracks the power that is demanded by the load 50. However, a potential challenge associated with this arrangement is that at low power operating points, the fuel cell stack and its auxiliary components may become very inefficient. Furthermore, the performance of the fuel cell stack 20 may become unstable when producing a relatively low level of power for the external load 50. To avoid these potential problems, in accordance with some embodiments of the invention, a technique may be used to isolate the fuel cell stack 20 from the external load 50 in response to the system power demand being very low or the stack 20 exhibiting unstable behavior at a low power operating point.

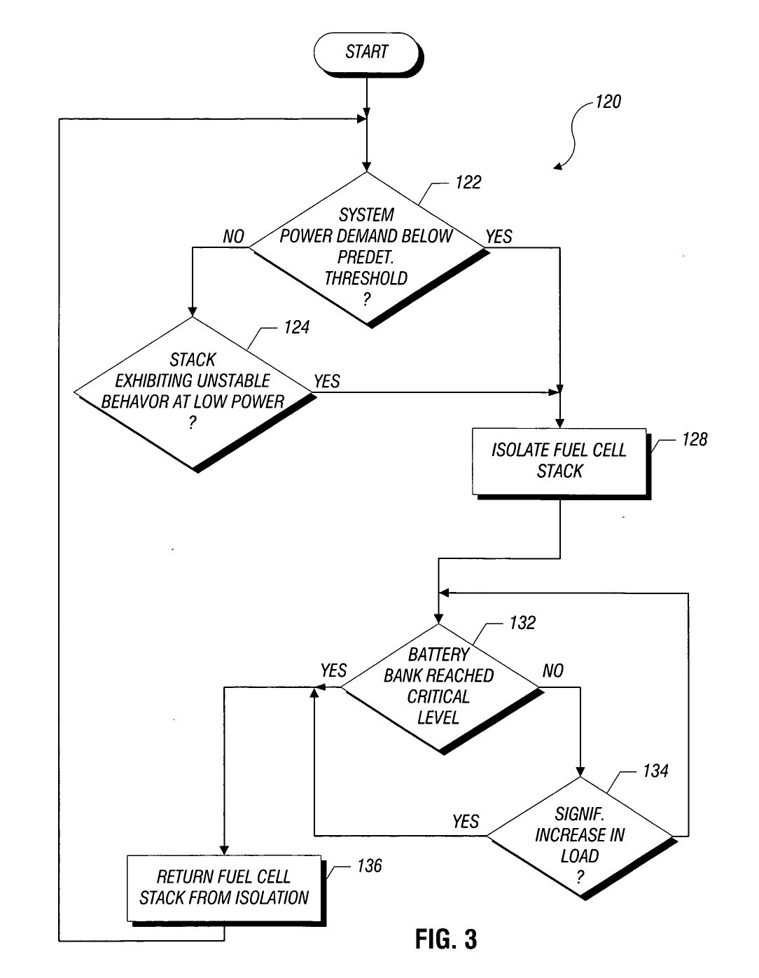

More specifically, in accordance with some embodiments of the invention, the fuel cell system 10 may use a technique 150 that is depicted in FIG. 3 for purposes of operating the fuel cell stack 20. Pursuant to the technique 120, the fuel cell system determines (diamond 122) whether the system power demand (the power demanded by the external load 50 and the power-consuming components of the fuel cell system 10) is below a predetermined threshold and determines (diamond 124) whether the stack 20 exhibits unstable behavior at a low operating setpoint. If either condition is true, then in accordance with the technique 120, the fuel cell system 10 isolates (block 128) the fuel cell stack 20 from the rest of the system 10.

As an example, this isolation may include closing the control valves 44 (FIG. 1) that supply reactant flows to the fuel cell stack 20 and electrically disconnecting the load 50 from the stack 20. The removal of reactants from the fuel cell stack 20 prevents the stack 20 from drying out while the load 50 is removed.

For purposes of electrically disconnecting the load 50 from the stack 20, in some embodiments of the invention, the fuel cell system 10 may include a switch 29 that is coupled in series between the fuel cell stack 20 and the load 50 so that by opening the switch 29, the fuel cell system 10 may disconnect the fuel cell stack 20 from the load 50.

While the fuel cell stack 20 is isolated, power for the load 50 is provided by the battery bank 41. The fuel cell system 10 subsequently considers two conditions that may cause the fuel cell system 10 to reconnect the fuel cell stack 20 to the system 10 to remove the stack 20 from isolation. First, the fuel cell system 10 determines (diamond 132) whether the battery bank 41 has reached a critical charge level. More specifically, with the battery bank 41 supplying the power for the load 50, eventually, the battery bank 41 may become sufficiently discharged so that supplemental power may be required from the fuel cell stack 20. Additionally, the fuel cell system 10 determines (diamond 134) whether there is a significant increase in the power that is demanded by the load 50.

If either one of these conditions occur, then, in accordance with the technique 120, the fuel cell system 10 returns (block 136) the fuel cell stack 20 from isolation. In other words, the fuel cell system 10 opens the control valves 44 to reestablish reactant flows to the fuel cell stack 20, brings the fuel processor 22 out of its idle state and closes the switch 29 to electrically connect the fuel cell stack 20 to the external load 50. Subsequently, the fuel cell stack 20 may provide the additional power needed by the load 50 and/or provide power needed to recharge the battery bank 41. Control returns to diamond 122 in which the fuel cell system 10 once again determines whether the system power demand has decreased below the predetermined threshold, as depicted in diamond 122.

Among the possible advantages for the technique 120, the fuel cell system 10 may have an increased system efficiency for a load profile that includes low power demands (power demands less than 1.5 kW for a system in which the stack 20 follows the load, as an example). The stability of the fuel cell system 10 may be increased. The system life of the fuel cell system 10 may be increased due to the reduced use of the stack 20 and auxiliary components at low power demands. Furthermore, the stack life may be increased due to less use of low current densities, where stack degradation rates may be greater. Other and different advantages may be possible, in other embodiments of the invention.

In some embodiments of the invention, the fuel cell system 10 may employ the technique 120 in conjunction with operating the fuel cell stack 20 at a fixed power output (a power output of about 5 kW, for example) when active. In these embodiments of the invention, the fuel cell system 10 may deem the system power low threshold point to be the fixed operating point of the stack 20. For example, when active, the fuel cell stack 20 may provide a constant output of about 5 kW. For this example, should the system power demand drop below 5 kW, then the fuel cell system 10 isolates the fuel cell stack 20 and proceeds in accordance with the technique 120. Other variations are possible.

In some embodiments of the invention, as set forth above, the fuel processor 22 may be operated at its lowest stable operating point when the fuel cell stack 20 is isolated from the system. However, this option may be challenging, in that the fuel processor 22 may be extremely inefficient when operating at this low operating point. Another option is to simply turn off the fuel processor 22 when the fuel cell stack 20 is isolated from the system. However, this option may be undesirable due to long startup time constants that are associated with turning on the fuel processor 22.

To address these challenges, in accordance with some embodiments of the invention, the fuel processor 22 is operated in a pulsed fashion when the fuel cell stack 20 is not operating. Because the need to provide reformate to the fuel cell stack 20 is not present when the fuel cell stack 20 is not operating, the fuel processor 22 is operated in a fashion that allows the fuel processor 22 to quickly start up and produce reformate quickly when the fuel cell stack 20 begins operating again.

More specifically, in accordance with some embodiments of the invention, the pulsing of the fuel processor 22 includes turning off incoming fuel to the processor 22 to allow the temperature inside the fuel processor 22 to slowly decrease. When the temperature decreases to a predetermined threshold, the incoming fuel to the fuel processor 22 is turned back on so that the processor 22 operates to restore its temperature to some nominal level. This technique is repeated until the need for reformate by the fuel cell stack 20 returns.

In addition to turning on and off the fuel flow to the fuel processor 22, in some embodiments of the invention, an oxidant flow to the flow processor 22 is turned on when the fuel flow to the processor 22 is turned on and turned off when the fuel flow to the processor is turned off.

In some embodiments of the invention, the “temperature” discussed in conjunction with pulsing the fuel processor 22 may be one of three following temperatures associated with the processor: a low temperature shift (LTS) temperature, an auto thermal reformer (ATR) temperature and an anode tail gas oxidizer (ATO) temperature. Thus, in some embodiments of the invention, should any of these three temperatures decrease below respective thresholds, then fuel cell system 10 reestablishes the fuel input flow to the fuel processor 22.

The thresholds for the ATO and ATR temperatures may be set based on the respective minimum temperatures that, when reached, cause associated heaters (normally off) to automatically turn on. Operation of one or both heaters may be relatively inefficient, as such operation may increase power losses and thus, decrease the system efficiency. Therefore, the low temperature thresholds for the ATO and ATR temperatures may be slightly above the minimum temperatures that cause the heaters to turn on. The threshold for the LTS temperature may be based on the desired time for the fuel processor 22 to turn back on and furnish the desired output reformate flow when the fuel flow to the fuel processor 22 is turned back on. In some embodiments of the invention, the threshold for the LTS temperature is selected so that the fuel processor 22 produces the appropriate level of reformate approximately five to ten minutes after the fuel flow to the reformer 22 is re-established.

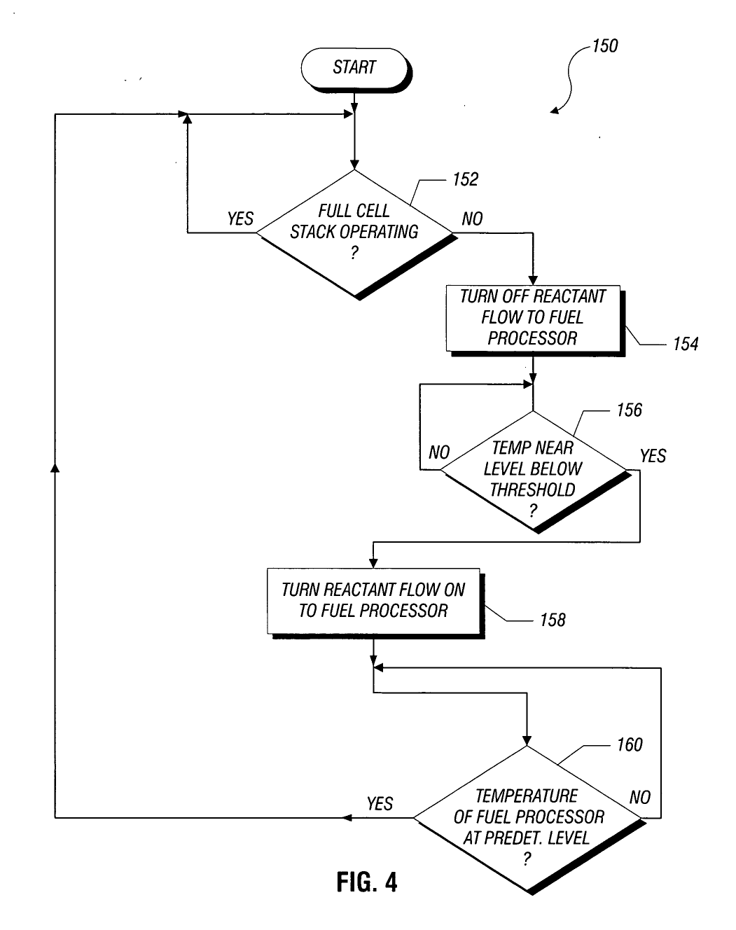

FIG. 4 depicts a technique 150, in accordance with some embodiments of the invention, for operating the fuel processor 22 in a pulsed fashion for purposes of maximizing the efficiency of the fuel processor 22 while permitting a fast turn on for the fuel processor 22 when reformate is needed by the stack 20. In accordance with the technique 150, the fuel cell system 10 determines (diamond 152) whether the fuel cell stack 20 is operating. If not, the fuel cell system 10 turns off the reactant flows (the fuel input flow and oxidant input flow) to the fuel processor 22, as depicted in block 154.

The turning off of the reactant flows to the fuel processor 22 causes the LTS, ATR and LTO temperatures inside the fuel processor 22 to decrease. Eventually, one of these temperatures reaches a point which the temperature is below its respective threshold. Thus, decreasing the temperature of the fuel processor 22 below this point may introduce significant transient times for bringing the fuel processor 22 back on line and may cause one or more heaters of the processor 22 to turn on.

Therefore, in accordance with the technique 150, the fuel cell system 10 determines (diamond 156) whether a temperature of the fuel processor 22 is below its respective minimum temperature threshold. If the temperature is near this point, then, in accordance with the technique 150, the fuel cell system 10 reestablishes the reactant flows to the fuel processor 22, as depicted in block 158. Subsequently, the fuel cell system 10 determines (diamond 160) whether the temperature of the fuel processor 22 has reached a predetermined nominal level. If so, then control returns to diamond 152 so that the pulsed operation may discontinue if the fuel cell stack 20 is not operating. Otherwise, the fuel cell system 10 continues with the above-described pulsed operation of the fuel processor 22.

Among the potential advantages of the technique 150, the system efficiency may be increased over a load profile that includes periods of low power demand from the load 50. Additionally, the life of the fuel cell system 10 may be increased due to the reduced use of catalysts and auxiliary components at periods of low power demand from the load 50. Other and different advantages may be possible in other embodiments of the invention.

Referring back to FIG. 1, among the other features of the fuel cell system 10, the battery monitoring circuit 43 may provide a signal (called CR) that when asserted (driven high, for example) indicates that the battery bank 41 needs to be charged. The battery monitoring circuit 43 may determine when the bank 41 needs to be charged by monitoring a terminal voltage (called V_{DC}) of the bank 41, a voltage that decreases below a predetermined threshold to indicate that charging is needed. Alternatively, the battery monitoring circuit 43 may monitor the V_{DC} voltage and a current of the bank 41 (via the current sensor 69) to monitor a net charge flowing out of the battery bank 41. In this manner, when the net charge exceeds a predetermined threshold, the battery monitoring circuit 43 asserts the CR signal. The battery monitoring circuit 43 may also determine when charging is complete by monitoring the current into the battery 41 (via the current sensor 69). In this manner, when the current approaches a predefined minimum threshold level, the battery monitoring circuit 43 deems the charging to be complete and de-asserts (drives low, for example) the CR signal. Other variations are possible.

The fuel cell system 10 includes a controller 60 that, among other things, receives the request (communicated over a communication line 47) from the battery monitoring circuit 43 to charge the battery bank 41 and controls other components (described below) of the fuel cell system 10 to cause the fuel cell stack 20 to charge the battery bank 41. In general, the controller 60 controls these and other components of the fuel cell system 10 to cause the fuel cell system 10 to perform one or more of the techniques 100, 120 and 150, depending on the particular embodiments of the invention.

More specifically, in accordance with some embodiments of the invention, the controller 60 may communicate with the fuel processor 22 (via electrical communication lines 46) to control operation of the fuel processor 22, adjust the setpoint of the fuel processor 22 and monitor a temperature (via a temperature sensor 23) of the fuel processor 22. Furthermore, the controller 60 may operate a control valve 19 that supplies hydrocarbons to the fuel processor 22 for purposes of selectively shutting off the fuel flow to the fuel processor 22. The controller 60 may also, in some embodiments of the invention, control (via electrical communication line 66) operation of the control valves 44.

In some embodiments of the invention, the controller 60 monitors the power that is consumed by the external load 50 and the parasitic elements of the fuel cell system 10 by monitoring the cell voltages, the terminal stack voltage (called “V_{TERM}”) and an output current (called “I1”) of the fuel cell stack 20. From these measurements, the controller 60 may determine when the fuel cell stack 20 is exhibiting unstable behavior at low power and may determine when the system power demand is below a predetermined threshold.

In some embodiments of the invention, the fuel cell system 10 includes a cell voltage monitoring circuit 40 to monitor the cell voltages of the fuel cell stack and the V_{TERM} stack voltage. Furthermore, the fuel cell system may include a sensor 49 to measure the I1 output current. The cell voltage monitoring circuit 40 communicates (via a serial bus 48, for example) indications of the measured cell voltages to the controller 60. The current sensor 49 is coupled in series with an output terminal 31 of the fuel cell stack 20 to provide an indication of the output current (via an electrical communication line 52). With the information about the power that is being demanded from the system and by the load 50 and information regarding the status of the fuel cell stack 20, the controller 60 may then perform one or more of the techniques 100, 120 and 150.

In some embodiments of the invention, the controller 60 may include one or more microprocessors or microcontrollers and may include a memory 63 that stores one or more programs 65. The programs 65, in turn, include instructions that when executed by the microprocessor(s)/microcontrollers(s) of the controller 60 cause the microprocessor(s)/microcontroller(s) to interact with the various components of the fuel cell system 10 for purposes of performing one or more of the techniques 100, 120 and 150.

Among the other features of the fuel cell system 10, the system 10 may include a DC-to-DC voltage regulator 30 that regulates the V_{TERM} stack voltage to produce the V_{DC} voltage that may be used to charge the bank 41 and may be converted into an AC voltage for the external load 50. In this manner, the fuel cell system 10 may include an inverter 33 that converts the V_{DC} voltage into an AC voltage that appears on output terminals 32 of the inverter 33 and system 10. Besides being controlled by the controller 60 to divert some of the fuel flow that is received by the fuel cell stack 20 to the oxidizer 38 via the conduit 55 (during the inactive isolation state of the stack 20, for example), the controller 60 may control the control valves 44 to shut off reactant flow to the stack 20 to isolate the stack 20 pursuant to the technique 120. The control valves 44 may also provide emergency shutoff of the oxidant and fuel flows to the fuel cell stack 20. The control valves 44 are coupled between inlet fuel 37 and oxidant 39 lines and the fuel and oxidant manifold inlets, respectively, to the fuel cell stack 20. The inlet fuel line 37 receives the fuel flow from the fuel processor 22, and the inlet oxidant line 39 receives the oxidant flow from the air blower 24. The fuel processor 22 receives a hydrocarbon (natural gas or propane, as examples) from the valve 19 and converts this hydrocarbon into the reformate (a hydrogen fuel flow, for example) that is provided to the fuel cell stack 20.

The fuel cell system 10 may include water separators, such as water separators 34 and 36, to recover water from the outlet and/or inlet fuel and oxidant ports of the fuel cell stack 20. The water that is collected by the water separators 34 and 36 may be routed to a water tank (not shown) of a coolant subsystem 54 of the fuel cell system 10. The coolant subsystem 54 circulates a coolant (de-ionized water, for example) through the fuel cell stack 20 to regulate the operating temperature of the stack 20.

For purposes of isolating the external load 50 from the fuel cell stack 20, the system 10 may include the switch 29 (a relay circuit, for example) that is coupled between the main output terminal 31 of the stack 20 and an input terminal of the current sensing element 49. The controller 60 may control operation of switch 29 via an electrical communication line 51.

In some embodiments of the invention, the controller 60 may include at least one microcontroller that includes a read only memory (ROM) that serves as at least part of the memory 63 that stores instructions for the program(s) 65. Other types of storage mediums may be used to store instructions for the program(s) 65. Various analog and digital external pins of the microcontroller(s)/microprocessor(s) of the controller 60 may be used to establish communication over the electrical communication lines 46, 51, 52 and 53; and the serial bus 48. In other embodiments of the invention, a memory that is fabricated on one or more separate die(s) or semiconductor packages may be used as the memory 63 and store instructions for the program(s) 65. Other variations are possible.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

1. A method usable with a fuel cell system, comprising:
using a stored energy source of the system to supply power to an external load to the system;
placing a fuel cell stack of the system in an inactive state during the using;
returning the fuel cell stack to an active state to recharge the stored energy source; and
returning the fuel cell stack to the inactive state in response to the completion of the charging.

2. The method of claim 1, further comprising:
only maintaining the fuel cell stack to the active state to recharge the stored energy source.

3. The method of claim 1, further comprising:
placing a fuel processor of the fuel cell system in an inactive state during the using; and
returning the fuel processor to the inactive state concurrent with the return of the fuel cell stack to the inactive state.

4. The method of claim 1, further comprising:
using the stored energy source to accommodate fluctuations in power demanded by the load.

5. The method of claim 1, further comprising:
operating the fuel cell stack only at a constant power level in the active state.

6. The method of claim 1, wherein the stored energy source comprises one or more battery cells.

7. A method comprising:
determining a system power demand in a fuel cell system; and
in response to the determination, isolating a fuel cell stack from the fuel cell system.

8. The method of claim 7, wherein the isolating comprises:
shutting off a reactant flow to the fuel cell stack.

9. The method of claim 7, wherein the isolating comprises:
electrically disconnecting the fuel cell stack from an external load to the fuel cell system.

10. The method of claim 7, wherein the isolating comprises:
placing a fuel processor of the fuel cell system in an idle state.

11. The method of claim 7, further comprising:
using a stored energy source to power an external load to the fuel cell system in response to the isolation of the fuel cell stack.

12. The method of claim 11, wherein the stored energy source comprises at least one battery cell.

13. The method of claim 11, further comprising:
determining whether the stored energy source has reached a minimum critical charge level; and
in response to the determination, returning the fuel cell stack from isolation.

14. The method of claim 11, further comprising:
determining whether a power demanded by an external load to the fuel cell system has significantly increased; and
based on the determination, returning the fuel cell stack from isolation.

15. A method usable with a fuel cell system, comprising:
determining whether the fuel cell stack is exhibiting unstable behavior during an interval of low power demand from the fuel cell stack; and
in response to the determination, isolating the fuel cell stack from fuel cell system.

16. The method of claim 15, wherein the isolating comprises:
shutting off a reactant flow to the fuel cell stack.

17. The method of claim 15, wherein the isolating comprises:
electrically disconnecting the fuel cell stack from an external load to the fuel cell system.

18. The method of claim 15, wherein the isolating comprises:
placing a fuel processor of the fuel cell system in an idle state.

19. The method of claim 15, further comprising:
using a stored energy source to power an external load to the fuel cell system in response to the isolation of the fuel cell stack.

20. The method of claim 19, wherein the stored energy source comprises at least one battery cell.

21. The method of claim 19, further comprising:
determining whether the stored energy source has reached a minimum critical charge level; and
in response to the determination, returning the fuel cell stack from isolation.

22. The method of claim 19, further comprising:
determining whether a power demanded by an external load to the fuel cell system has significantly increased; and
based on the determination, returning the fuel cell stack from isolation.

23. A method usable with a fuel cell system, comprising:
pulsing a fuel processor with an input reactant flow to minimize at least one of a power loss and a start up time of the fuel processor.

24. The method of claim 23, wherein the pulsing comprises:
turning off of a fuel flow to the fuel processor;
determining whether a temperature of the fuel processor is near a self-ignition threshold of the fuel processor; and
based on the determination, selectively turning on the fuel flow to the fuel processor.

25. The method of claim 23, wherein the pulsing occurs in response to a fuel cell stack to which the fuel processor provides reformate becoming inactive.

26. A fuel cell system, comprising:
a stored energy source to supply power to an external load of the fuel cell system;
a fuel cell stack; and
a controller adapted to:
place the fuel cell stack in an inactive state during a time interval in which the stored energy source supplies power to the load,
return the fuel cell stack to an active state to recharge the stored energy source, and
return the fuel cell stack to the inactive state in response to the completion of the charging of the stored energy source.

27. The system of claim 26, wherein the controller is further adapted to only return the fuel cell stack to the active state to recharge the stored energy source.

28. The system of claim 26, further comprising:
a fuel processor,
wherein the controller is further adapted to place the fuel processor in an inactive state during the time interval and return the fuel processor to the inactive state concurrent with the return of the fuel cell stack to the inactive state.

29. The system of claim 26, wherein the stored energy source is adapted to accommodate fluctuations in power demanded by the load.

30. The system of claim 26, wherein the fuel cell stack is adapted to be operated only at a constant power level in the active state.

31. The system of claim 26, wherein the stored energy source comprises one or more battery cells.

32. A fuel cell system comprising:
a fuel cell stack; and
a controller adapted to determine a system power demand in the fuel cell system and in response to the determination, isolate the fuel cell stack from the fuel cell system.

33. The system of claim 32, further comprising:
a valve controlling a reactant flow to the fuel cell stack,
wherein the controller is further adapted to at least control the valve to shut off the reactant flow to the fuel cell stack to isolate the fuel cell stack from the fuel cell system.

34. The system of claim 32, further comprising:
an electrical switch,
wherein the controller is further adapted to at least control the switch to electrically disconnect the fuel cell stack from an external load to the fuel cell system.

35. The system of claim 32, further comprising:
a fuel processor,
wherein the controller is further adapted to at least place the fuel processor in an idle state to isolate the fuel cell stack from the fuel cell system.

36. The system of claim 32, further comprising:
a stored energy source adapted to power an external load to the fuel cell system in response to the isolation of the fuel cell stack.

37. The system of claim 36, wherein the stored energy source comprises at least one battery cell.

38. The system of claim 36, wherein the controller is further adapted to determine whether the stored energy source has reached a minimum critical charge level and in response to the determination, return the fuel cell stack from isolation.

39. The system of claim 36, wherein the controller is further adapted to determine whether a power demanded by an external load to the fuel cell system has significantly increased and based on the determination, return the fuel cell stack from isolation.

40. A fuel cell system comprising:
a fuel cell stack; and
a controller adapted to determine whether the fuel cell stack is exhibiting unstable behavior during an interval of low power demand from the fuel cell stack and in response to the determination, isolate the fuel cell stack from the fuel cell system.

41. The system of claim 40, further comprising:
a valve controlling a reactant flow to the fuel cell stack,
wherein the controller is further adapted to at least control the valve to shut off the reactant flow to the fuel cell stack to isolate the fuel cell stack from the fuel cell system.

42. The system of claim 40, further comprising:
an electrical switch,
wherein the controller is adapted to control the switch to electrically disconnect the fuel cell stack from an external load to the fuel cell system.

43. The system of claim 40, further comprising:
a fuel processor,
wherein the controller is adapted to place the fuel processor in an idle state to isolate the fuel cell stack from the fuel cell system.

44. The system of claim 40, further comprising:
a stored energy source adapted to power an external load to the fuel cell system in response to the isolation of the fuel cell stack.

45. The system of claim 44, wherein the stored energy source comprises at least one battery cell.

46. The system of claim 44, wherein the controller is further adapted to determine whether the stored energy source has reached a minimum critical charge level and in response to the determination, return the fuel cell stack from isolation.

47. The system of claim 44, wherein the controller is further adapted to determine whether a power demanded by an external load to the fuel cell system has significantly increased and based on the determination, return the fuel cell stack from isolation.

48. A fuel cell system comprising:
a fuel processor;
a valve to control a reactant flow input to the fuel processor; and
a controller adapted to control the valve to pulse the fuel processor with the reactant flow to minimize at least one of a power loss and a startup time of the fuel processor.

49. The system of claim 48, wherein the controller is further adapted to:
control the valve to turn off fuel to the fuel processor;
determine whether a temperature of the fuel processor is near a self-ignition threshold of the fuel processor; and
based on the determination, control the valve to selectively turn on the reactant flow to the fuel processor.

50. The system of claim 48, wherein the controller is further adapted to control the valve to pulse the fuel input to the fuel processor in response to a fuel cell stack to which the fuel processor provides reformate becoming inactive.

51. An article comprising a computer readable storage medium storing instructions that when executed cause a processor-based system to:
place a fuel cell stack of a fuel cell system in an inactive state during a time interval in which a stored energy source of the system supplies power to an external load;
return the fuel cell stack to an active state to recharge the stored energy source; and
return the fuel cell stack to the inactive state in response to the completion of the charging of the stored energy source.

52. The article of claim 51, the storage medium storing instructions to cause the processor-based system to only return the fuel cell stack to the active state to recharge the stored energy source.

53. An article comprising a computer readable storage medium storing instructions that when executed cause a processor-based system to:
determine a system power demand in a fuel cell system; and
in response to the determination, isolate a fuel cell stack from the fuel cell system.

54. The article of claim 53, the storage medium storing instructions to cause the processor-based system to isolate the fuel cell stack by performing at least one of the following:
shutting off a reactant flow to the fuel cell stack;
electrically disconnecting the fuel cell stack from an external load to the fuel cell system; and
placing a fuel processor of the fuel cell system in an idle state.

55. An article comprising a computer readable storage medium storing instructions that when executed cause a processor-based system to:
determine whether a fuel cell stack of a fuel cell system is exhibiting unstable behavior during an interval of lower demand from the fuel cell stack; and
in response to the determination, isolate the fuel cell stack from the fuel cell system.

56. The article of claim 55, the storage medium storing instructions to cause the processor-based system to isolate the fuel cell stack by performing at least one of the following:
shutting off a reactant flow to the fuel cell stack;
electrically disconnecting the fuel cell stack from an external load to the fuel cell system; and
placing a fuel processor of the fuel cell system in an idle state.

57. An article comprising a computer readable storage medium storing instructions that when executed cause a processor-based system to:
pulse a fuel processor of a fuel cell system with an input reactant flow to minimize at least one of a power loss and a startup time of the fuel processor.

58. The article of claim 57, the storage medium storing instructions that when executed cause the processor-based system to pulse the fuel processor by performing at least the following:
turning off fuel to the fuel processor, determine whether a temperature of the fuel processor is near a self-ignition threshold of the fuel processor,
based on the determination, selectively turning on fuel to the fuel processor.
